(19) United States
(12) Patent Application Publication
(10) Pub. No.: US 2021/0373428 A1
(43) Pub. Date: Dec. 2, 2021

(54) VEHICLE CAMERA UNIT

(71) Applicant: TOYODA GOSEI CO., LTD., Kiyosu-shi (JP)

(72) Inventors: Hitoshi HORIBE, Kiyosu-shi (JP); Masayuki KITASHIBA, Kiyosu-shi (JP)

(21) Appl. No.: 17/333,221

(22) Filed: May 28, 2021

(30) Foreign Application Priority Data
Jun. 2, 2020 (JP) 2020-096509

(51) Int. Cl. G03B 30/00; B60R 13/04; H04N 5/225; B60R 11/04

(52) U.S. Cl. CPC G03B 30/00; B60R 13/04; B60R 2011/004; B60R 11/04; H04N 5/2251

(57) ABSTRACT

A vehicle camera unit includes: a back camera mounted to a rear part of a vehicle, to take an image rearward; a garnish member provided rearward of the back camera; and a body-side member provided upward of the garnish member. The back camera has a rearward-directed lens. The garnish member includes a transmitting portion which is a half mirror and covering the lens at least from a rear side, and a design portion provided upward of the transmitting portion and covering a lower part of the back camera from a rear upper side. The design portion is a half mirror or has a smaller visible light transmittance than the transmitting portion. The body-side member has, at a lower end, a recessed attachment portion having a groove shape that opens rearward. The design portion has, at an upper end, a projecting attachment portion entering into the recessed attachment portion.

### TECHNICAL FIELD

The present invention relates to a vehicle camera unit including a back camera.

### BACKGROUND ART

In recent years, technology of mounting, at a rear part of a vehicle, a back camera for taking an image rearward of the vehicle, has been generally used. The back camera takes an image rearward of the vehicle and the obtained image is provided to a driver, whereby the driver can easily and accurately recognize the state of a road rearward of the vehicle, presence/absence of a pedestrian, and the like. Thus, mounting the back camera to the vehicle is advantageous in terms of improvement in safety of back parking, protection of a pedestrian, and the like.

In general, the back camera is provided at a rear lower part of the vehicle. The back camera provided at such a position is allowed to take an image around a road surface rearward of the vehicle but has difficulty in taking an image over a wide range rearward of the vehicle.

In recent years, in terms of safety in traveling, there is an increasing requirement to detect a wide range rearward of the vehicle and acquire data of a traveling condition of a following vehicle, a road condition, and the like.

Japanese Patent No. 6524395 proposes, in embodiment 1 and FIG. 3, technology that a back camera is provided at a comparatively highposition on the rear side of a vehicle, specifically, at a position upward of a license plate, and a lens of the back camera is directed in not the immediately downward direction but a rearward direction.

Providing the back camera as described above is considered to enable the back camera to take an image over a comparatively wide range rearward of the vehicle and thus enable acquisition of data of a traveling condition of a following vehicle, a road condition, and the like.

### SUMMARY OF INVENTION

### Technical Problem

Here, providing the back camera at the upward position and directing the lens of the back camera in the rearward direction enables the back camera to take an image over a comparatively wide range rearward of the vehicle. Meanwhile, the back camera is readily visually recognized by a user, a passerby, and the like, leading to deterioration in the design of the vehicle. Japanese Patent No. 6524395 shows, in FIG. 3, that a lens 32 of a back camera 30 is exposed at a position downward of a decoration member 20, i.e., a garnish.

The present invention has been made in view of the above circumstances, and an object of the present invention is to provide, in a vehicle camera unit including a back camera, technology that enables an image rearward of a vehicle to be taken and contributes to improvement in the design of the vehicle.

### Solution to Problem

In order to achieve the above object, a vehicle camera unit according to the present invention includes: a back camera mounted to a rear part of a vehicle and configured to take an image rearward; a garnish member provided rearward of the back camera; and a body-side member provided upward of the garnish member, wherein the back camera has a lens directed rearward, the garnish member includes a transmitting portion which is a half mirror and covering the lens at least from a rear side, and a design portion provided upward of the transmitting portion and covering a lower part of the back camera from a rear upper side, the design portion is a half mirror or a visible light transmittance of the design portion is smaller than a visible light transmittance of the transmitting portion, the body-side member has, at a lower end thereof, a recessed attachment portion having a groove shape that opens rearward, and the design portion has, at an upper end thereof, a projecting attachment portion entering into the recessed attachment portion.

The vehicle camera unit according to the present invention enables an image rearward of a vehicle to be taken and contributes to improvement in the design of the vehicle.

### BRIEF DESCRIPTION OF DRAWINGS

FIG. 1 schematically illustrates a state in which a vehicle camera unit of embodiment 1 is mounted on a vehicle;

FIG. 2 schematically illustrates a part other than a garnish member and a body-side member in the vehicle camera unit of embodiment 1;

FIG. 3 schematically illustrates a part other than the body-side member in the vehicle camera unit of embodiment 1;

FIG. 4 schematically illustrates a cross-section of the vehicle camera unit of embodiment 1 taken along a centerline in the vehicle width direction; and

FIG. 5 schematically illustrates another example of a parting portion between the garnish member and the body-side member in the vehicle camera unit of the present invention.

### DESCRIPTION OF EMBODIMENTS

A vehicle camera unit of the present invention includes a back camera, a garnish member, and a body-side member. Among these, the back camera is mounted to a rear part of a vehicle and takes an image rearward.

The garnish member is provided rearward of the back camera.

In the vehicle camera unit of the present invention, a lens of the back camera is covered by a transmitting portion at least from a rear side, and a lower part of the back camera is covered by a design portion from a rear upper side.

The transmitting portion is a half mirror. Therefore, the back camera is allowed to take an image rearward of the vehicle through the transmitting portion, and the lens of the back camera is hardly visually recognizable from the rear side of the vehicle by a user, a passerby, or the like.

The design portion is a half mirror or the visible light transmittance of the design portion is smaller than the visible light transmittance of the transmitting portion. Therefore, the lower part of the back camera covered by the design portion is also hardly visually recognizable from the rear side of the vehicle by the user or the like.

As described above, the lower part and the lens of the back camera are visually hidden from the rear side of the vehicle. Therefore, the vehicle camera unit of the present invention contributes to improvement in the design of the vehicle while allowing an image rearward of the vehicle to be taken.

Further, the vehicle camera unit of the present invention includes a body-side member provided upward of the garnish member.

The body-side member has, at a lower end thereof, a recessed attachment portion having a groove shape that opens rearward. Meanwhile, the design portion which is, of the garnish member, a part located on the body-side member side has, at an upper end thereof, a projecting attachment portion entering into the recessed attachment portion of the body-side member. In other words, at a parting portion between the garnish member and the body-side member, the upper end of the garnish member enters into the recessed groove provided at the lower end of the body-side member, so as to be covered by the body-side member. Thus, the vehicle camera unit of the present invention exhibits an excellent design also at the parting portion between the garnish member and the body-side member.

Also by this, the vehicle camera unit of the present invention contributes to improvement in the design of the vehicle.

Hereinafter, the vehicle camera unit of the present invention will be described for constituent components thereof individually.

The vehicle camera unit of the present invention includes the back camera, the garnish member, and the body-side member.

As the back camera, a general camera capable of taking a moving image and/or a still image may be used, and an imaging type thereof is not particularly limited.

The back camera is provided with the lens directed rearward. The back camera may have only one lens or may have a plurality of lenses. In a case where the back camera has a plurality of lenses, the lens located on the most upstream side of an optical path directed from the outside to the back camera, in other words, located at a position closest to an object to be imaged, corresponds to the “lens” directed rearward by the back camera in the present invention.

The lens located closest to the object to be imaged is considered to be a lens that is most likely to be visually recognized from the outside.

The back camera is provided with the lens directed in not the immediately downward direction but the rearward direction, and thus is allowed to take an image rearward of the vehicle. As described above, the lens is covered from the rear side by the transmitting portion which is a half mirror, of the garnish member. Therefore, even though the lens is directed in not the immediately downward direction but the rearward direction, the lens is less likely to be visually recognized by the user or the like. Thus, the design of the vehicle on which the vehicle camera unit of the present invention is mounted is not impaired.

Preferably, the back camera in the vehicle camera unit of the present invention is provided with the lens directed in the rearward downward direction. When the lens is directed in the rearward downward direction, i.e., a direction slightly downward with respect to the immediately rearward direction, the lens is even less likely to be visually recognized by the user or the like, thus making further contribution to improvement in the design of the vehicle on which the vehicle camera unit of the present invention is mounted.

Here, the immediately downward direction refers to the downward direction in the vertical direction. In addition, the immediately rearward direction refers to the rearward direction in the horizontal direction. In the vehicle camera unit of the present invention, the “rearward direction” which is the direction of the lens of the back camera refers to a direction between the downward direction in the vertical direction and the upward direction in the vertical direction. Preferably, the direction of the lens is a rearward downward direction, i.e., a direction between the downward direction in the vertical direction and the rearward direction in the horizontal direction. More preferably, the angle at which the direction of the lens of the back camera crosses the vertical direction is in any of a range not less than 5° and not greater than 85°, a range not less than 5° and not greater than 60°, a range not less than 10° and not greater than 45°, and a range not less than 15° and not greater than 45°.

The garnish member includes the transmitting portion and the design portion. The transmitting portion is a half mirror. The characteristics of the half mirror, specifically, the visible light transmittance, the visible light reflectance, and the ratio between the visible light transmittance and the visible light reflectance may be appropriately selected in accordance with a design required for the garnish member, the attachment position of the garnish member to the vehicle, and the like, and are not particularly limited in the present invention. As a matter of course, the ratio between the visible light transmittance and the visible light reflectance is not limited to 50:50. A preferable range of the ratio between the visible light transmittance and the visible light reflectance is, as an example, 70:30 to 10:90.

The transmitting portion only has to cover the lens of the back camera at least from the rear side, and may cover the lens of the back camera further from a side other than the rear side. The transmitting portion may cover apart other than the lens, in addition to the rear side of the lens. The rear side mentioned here refers to a side in the aforementioned rearward direction. The direction of the lens and the direction of the transmitting portion covering the lens may not necessarily coincide with each other. However, in a case where the lens is directed in the rearward downward direction, preferably, the transmitting portion is also directed in the rearward downward direction.

The design portion is provided upward of the transmitting portion and covers the lower part of the back camera from the rear upper side. Since the design portion is a half mirror or the visible light transmittance of the design portion is smaller than the visible light transmittance of the transmitting portion, the lower part of the back camera hidden by the design portion is less likely to be visually recognized from the rear upper side of the vehicle. Since the transmitting portion and the design portion as described above are provided, the garnish member in the vehicle camera unit of the present invention visually isolates the lower part and the lens of the back camera from the rear side of the vehicle.

In a case where the design portion is a half mirror, the characteristics of the half mirror forming the design portion, i.e., the visible light transmittance and the visible light reflectance thereof, may be the same as these characteristics of the half mirror forming the transmitting portion, or may be different therefrom.

In a case where the visible light transmittance of the design portion is smaller than the visible light transmittance of the transmitting portion, the visible light transmittance of the design portion only has to be a value smaller than the visible light transmittance of the transmitting portion, and the degree thereof is not particularly limited. A preferable range of the visible light transmittance of the design portion may be, as an example, not greater than 90%, not greater than 70%, not greater than 50%, or not greater than 30% of the visible light transmittance of the transmitting portion. Note that the visible light transmittance of the design portion may be 0% and therefore the above range does not have a lower limit.

The material of the garnish member is not particularly limited. Of the garnish member, the transmitting portion is required to allow visible light to transmit therethrough to the back camera, in order to take an image rearward of the vehicle by the back camera.

Although the material of the transmitting portion is not particularly limited, for example, a composite resin material obtained by forming a coat layer having visible light reflectivity on a base made of transparent resin such as acrylic resin or polycarbonate, may be used. The material and the thickness of the coat layer may be appropriately selected in accordance with the visible light transmittance and the visible light reflectance required for the transmitting portion.

Of the garnish member, the design portion may not have visible light transmitting property and may be made of any material. However, in light of cost, the design portion preferably has a base made of transparent resin in common with the transmitting portion.

The design portion is required to be a half mirror or the visible light transmittance thereof is required to be smaller than the visible light transmittance of the transmitting portion. Therefore, in a case where the design portion has a base made of transparent resin, a coat layer for controlling transmission of visible light needs to be formed on the base. Hereinafter, as necessary, the coat layer of the design portion is referred to as a design coat layer, and the coat layer of the transmitting portion is referred to as a transmitting coat layer, so as to discriminate both layers.

The design coat layer may have visible light reflectivity, as with the transmitting coat layer. In this case, as well as the transmitting portion, the design portion is also a half mirror.

The design coat layer may be different from the transmitting coat layer.

Here, the garnish member is a kind of exterior component of a vehicle, and is exposed outside the vehicle. Therefore, in general, the garnish member is provided with various kinds of designs.

Specifically, the garnish member may exhibit various kinds of designs by plating, painting, printing, transfer, or the like, and the design portion of the garnish member may have a design coat layer formed by plating, painting, printing, transfer, or the like. In order to hide the lower part and the lens of the back camera by the design portion, preferably, a material having low visible light transmitting property is selected as paint, ink, or the like for the design coat layer, and particularly preferably, plating or the like not having visible light transmitting property is selected.

Preferably, the design portion has a design surface facing a rear upper side. In a case where the position of the eyes of the user, a pedestrian, or the like is higher than the position of the design surface in the vehicle camera unit of the present invention, the user or the like sees the vehicle camera unit of the present invention from the rear upper side. When the design portion in the vehicle camera unit of the present invention has the design surface facing the rear upper side, attention of the user or the like is first attracted to the design surface facing the rear upper side.

The design portion is a half mirror or the visible light transmittance of the design portion is smaller than the visible light transmittance of the transmitting portion. That is, the design portion has a function of visually isolating the lower part of the back camera from the rear side of the vehicle, at a degree equal to or greater than that of the transmitting portion. With the design portion as described above, the design surface is formed so as to be visually attended by the user or the like, whereby the attention of the user or the like is taken away from the transmitting portion. Thus, the lens of the back camera is less likely to be visually recognized by the user or the like, and deterioration in the design of the vehicle on which the vehicle camera unit of the present invention is mounted is suppressed.

The lens of the back camera readily attracts attention of the user because of the shape thereof, as with a lens of a general camera. Therefore, taking the attention of the user away from the lens of the back camera significantly contributes to improvement in the design of the vehicle on which the vehicle camera unit of the present invention is mounted.

The vehicle camera unit of the present invention includes the body-side member, in addition to the back camera and the garnish member described above. The body-side member is a separate member from the garnish member.

As the body-side member, an appropriate member may be selected in accordance with the attachment position of the back camera. For example, in a case where the back camera is provided downward of a back door, a rear bumper may be selected as the body-side member. The rear bumper as the body-side member may be a member integrated with a body, or may be a separate member from the body. In another example, in a case where the back camera is provided to the back door, a door panel of the back door may be selected as the body-side member.

The body-side member has, at the lower end thereof, the recessed attachment portion having the groove shape that opens rearward. The design portion of the garnish member provided downward of the body-side member has, at the upper end thereof, the projecting attachment portion entering into the recessed attachment portion. As described above, since the projecting attachment portion of the design portion enters into the recessed attachment portion of the body-side member, a substantial parting portion between the body-side member and the design portion is hidden in the groove of the recessed attachment portion, whereby the design at the parting portion between the body-side member and the design portion is improved.

In the vehicle camera unit of the present invention, of the garnish member, the part covering the lens of the back camera, i.e., the transmitting portion is a half mirror. Therefore, the back camera is allowed to take an image rearward of the vehicle through the transmitting portion, and the lens of the back camera is hidden by the transmitting portion and thus is less likely to be visually recognized from the rear side of the vehicle.

Further, of the back camera, the lower part located upward of the lens is covered by the design portion of the garnish member from the rear upper side. Owing to cooperation of these portions, the back camera is hidden by the garnish member in various aspects.

Therefore, the vehicle camera unit of the present invention does not impair the design of the vehicle, not only when the vehicle camera unit is provided at a vehicle lower part but also when the vehicle camera unit is provided at a vehicle center part or a vehicle upper part in the up-down direction. In other words, the vehicle camera unit of the present invention is suitable as a vehicle camera unit provided upward of the vehicle lower part.

Examples of preferable mounting positions of the vehicle camera unit of the present invention to the vehicle include a position upward of the lower end of the bumper, a position upward of the bumper, a position upward of the lower end of a license plate, a position upward of the license plate, and a position upward of the lower end of the back door.

In a case where the vehicle camera unit of the present invention is provided upward of the license plate, the vehicle camera unit of the present invention preferably has a license lamp for illuminating the license plate.

In recent years, various on-vehicle devices have been provided to a vehicle. Among these, many of devices provided at a vehicle rear part are preferably located at a center position in the vehicle width direction. Specifically, a back camera for taking an image rearward of the vehicle, a license lamp for illuminating a license plate, a handle for opening/closing a back door, and the like are preferably located at a center position in the vehicle width direction.

However, a center part in the vehicle width direction at the vehicle rear part does not have enough space to place all of such on-vehicle devices therein. Therefore, in many cases, some of these on-vehicle devices are provided at ends in the vehicle width direction, to solve the problem of insufficient space described above.

The vehicle camera unit of the present invention is suitable as a vehicle camera unit provided upward of the vehicle lower part as described above. That is, providing the vehicle camera unit of the present invention upward of the handle and/or the license lamp described above enables all or most of the above devices to be located at a center position in the vehicle width direction. Preferably, the vehicle camera unit of the present invention as described above includes the handle of the back door and the license lamp.

In a case where the vehicle camera unit of the present invention is provided at a part whose state changes, e.g., the back door in the vehicle, the directions in the vehicle camera unit also change. In this case, the directions in the vehicle camera unit refer to directions when the vehicle on which the vehicle camera unit is mounted is in a traveling possible condition. That is, in a case where the vehicle camera unit of the present invention is provided to the back door, the transmitting portion of the garnish member covers the lens of the back camera from the rear side when the back door is closed. In addition, the design portion of the garnish member covers the lower part of the back camera from the rear upper side when the back door is closed.

Also in a case where the vehicle camera unit of the present invention does not include the body-side member, i.e., includes only the back camera and the garnish member, the vehicle camera unit of the present invention provides the effect of visually isolating the lower part and the lens of the back camera from the rear side of the vehicle by the transmitting portion and the design portion of the garnish member, while allowing the back camera to take an image through the transmitting portion of the garnish member. That is, also in this case, the object of the present invention to “provide technology that enables an image rearward of a vehicle to be taken and contributes to improvement in the design of the vehicle”, is achieved.

Another aspect of the vehicle camera unit of the present invention is a vehicle camera unit not including the body-side member.

That is, in order to achieve the above object, the vehicle camera unit of the present invention includes: a back camera mounted to a rear part of a vehicle and configured to take an image rearward; and a garnish member provided rearward of the back camera, wherein the back camera has a lens directed rearward, the garnish member includes a transmitting portion which is a half mirror and covering the lens at least from a rear side, and a design portion provided upward of the transmitting portion and covering a lower part of the back camera from a rear upper side, and the design portion is a half mirror or a visible light transmittance of the design portion is smaller than a visible light transmittance of the transmitting portion.

Further, a case where the vehicle camera unit of the present invention does not include the body-side member and the design portion, in other words, a case where the garnish member is composed of only the transmitting portion, will be discussed.

In this case, instead of the design portion, if a door panel of the back door, the rear bumper, or the like located rearward of the back camera covers the lower part of the back camera from the rear upper side at a position upward of the transmitting portion, the lower part of the back camera is hidden from the rear upper side by the door panel or the like described above. As a matter of course, also in this case, the lens of the back camera is hidden from the rear side while the back camera is allowed to take an image rearward of the vehicle through the transmitting portion which is a half mirror.

Therefore, also in this case, the object of the present invention to “provide technology that enables an image rearward of a vehicle to be taken and contributes to improvement in the design of the vehicle”, is achieved.

Still another aspect of the vehicle camera unit of the present invention is a vehicle camera unit not including the body-side member and the design portion of the garnish member.

That is, in order to achieve the above object, the vehicle camera unit of the present invention includes: a back camera mounted to a rear part of a vehicle and configured to take an image rearward; and a garnish member provided rearward of the back camera, wherein the back camera has a lens directed rearward, and the garnish member includes a transmitting portion which is a half mirror and covering the lens at least from a rear side.

Hereinafter, the vehicle camera unit of the present invention will be described using a specific example.

### Embodiment 1

A vehicle camera unit according to embodiment 1 is mounted to a back door of a vehicle, and is provided upward of a license plate. A body-side member in the vehicle camera unit of embodiment 1 is a door panel of the back door.

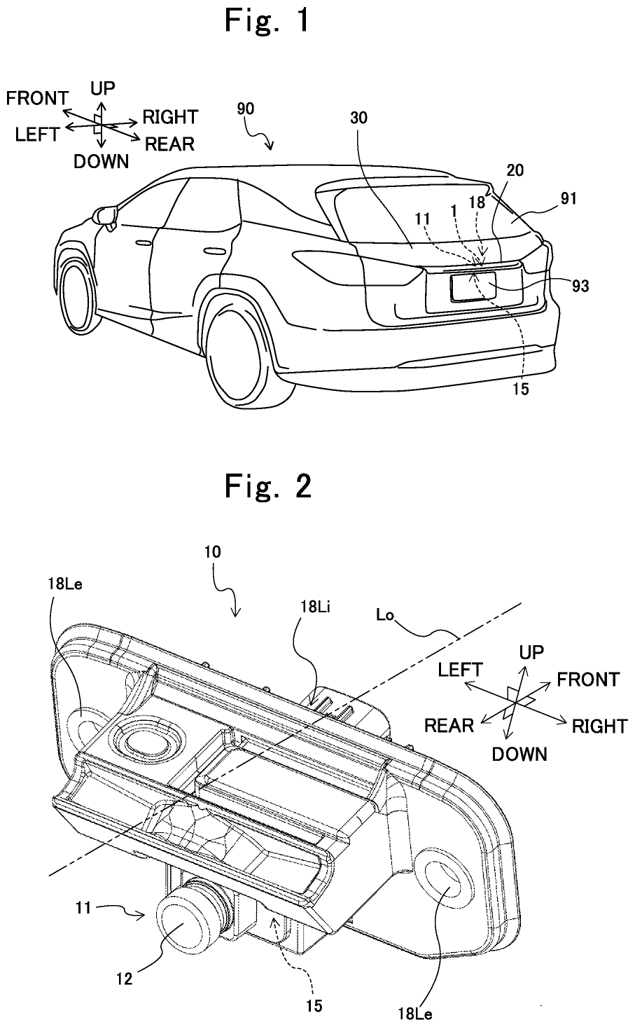

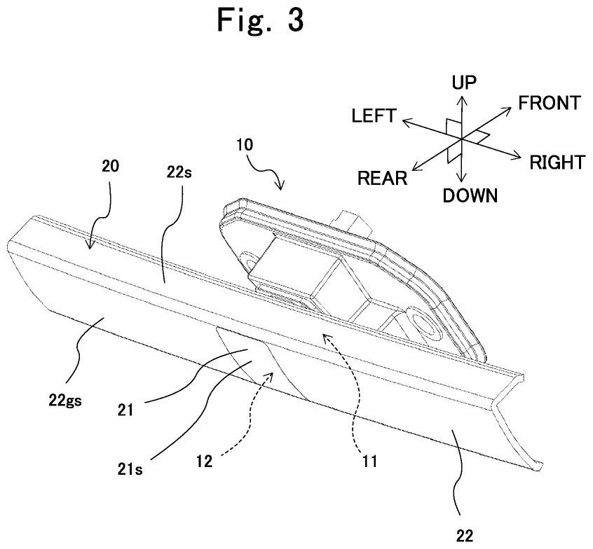

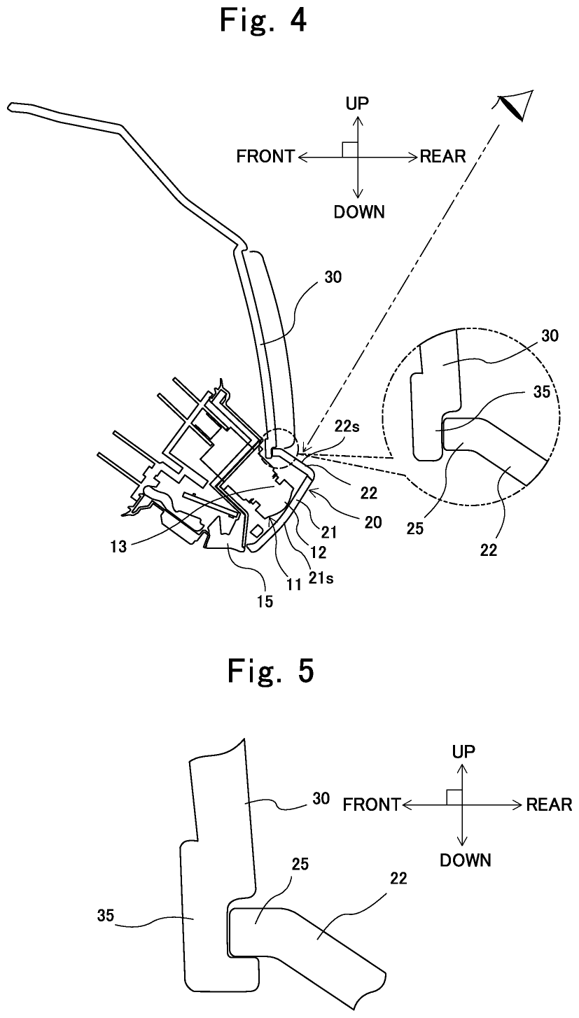

FIG. 1 schematically illustrates a state in which the vehicle camera unit of embodiment 1 is mounted on the vehicle, FIG. 2 schematically illustrates a part other than a garnish member and the body-side member in the vehicle camera unit of embodiment 1, FIG. 3 schematically illustrates a part other than the body-side member in the vehicle camera unit of embodiment 1, and FIG. 4 schematically illustrates a cross-section of the vehicle camera unit of embodiment 1 taken along a center line in the vehicle width direction. FIG. 4 includes an enlarged view of a parting portion between the garnish member and the body-side member. FIG. 5 shows another example of the parting portion between the garnish member and the body-side member in the vehicle camera unit of the present invention. FIG. 5 schematically illustrates a cross-section of the garnish member and the body-side member at the same position as in FIG. 4.

Hereinafter, up, down, left, right, front, and rear refer to up, down, left, right, front, and rear shown in the drawings. The up-down direction corresponds to the vertical direction, the front-rear direction corresponds to the vehicle advancing direction, and the left-right direction corresponds to the vehicle width direction.

As shown in FIG. 1, a vehicle camera unit 1 of embodiment 1 is mounted to a back door 91 of a vehicle 90.

The vehicle camera unit 1 of embodiment 1 includes a back camera sub-unit 10 shown in FIG. 2, a garnish member 20 shown in FIG. 3, and a body-side member 30 shown in FIG. 1.

The back camera sub-unit 10 includes a back camera 11, a handle 15 of the back door 91, and a license lamp 18.

As shown in FIG. 4, the handle 15 is provided downward of the back camera 11. As shown in FIG. 2, the license lamp 18 includes a light source 18Li and a pair of lenses 18Le. A center line Lo in the vehicle width direction passes the light source 18Li, the handle 15, and the back camera 11. The pair of lenses 18Le of the license lamp 18 are arranged symmetrically in the vehicle width direction with the light source 18Li therebetween. Therefore, the center between the pair of lenses 18Le is also on the center line Lo. As shown in FIG. 2, the light source 18Li of the license lamp 18 is provided frontward of the handle 15 and a lens 12 of the back camera 11. The license lamp 18 illuminates the license plate 93 from the left and right sides at a position upward of the license plate 93.

As shown in FIG. 2 to FIG. 4, the back camera 11 is provided with the lens 12 directed in the rearward downward direction.

As shown in FIG. 3, the garnish member 20 is provided rearward of the back camera sub-unit 10. The garnish member 20 includes a transmitting portion 21 and a design portion 22, and has a long shape extending in the left-right direction, i.e., the vehicle width direction, as a whole.

The transmitting portion 21 has a rectangular shape and is provided at a center in the vehicle width direction in a lower part in the up-down direction of the garnish member 20.

Of the garnish member 20, a part other than the transmitting portion 21 is the design portion 22. The lower part of the design portion 22 extends in the left-right direction as shown in FIG. 3, and extends from the front lower side to the rear upper side as shown in FIG. 4. The upper part of the design portion 22, i.e., a part having a design surface 22s described later extends in the left-right direction as shown in FIG. 3, and is bent toward the front upper side from the lower part (not shown) of the design portion 22 and the transmitting portion 21 as shown in FIG. 4.

As shown in FIG. 3 and FIG. 4, the transmitting portion 21 has a transmitting surface 21s facing in the rearward downward direction. The design portion 22 has the design surface 22s facing in the rearward upward direction, and a general surface 22gs flush with the transmitting surface 21s. The transmitting portion 21 and the design portion 22 are each obtained by forming a coat layer (not shown) on abase (not shown) made of transparent resin. A transmitting coat layer which is the coat layer of the transmitting portion 21 is a mirror-surface coat having a visible light transmittance and a visible light reflectance at approximately 1:1, and the transmitting portion 21 is a half mirror. A design coat layer which is the coat layer of the design portion 22 is a plating layer formed by electroless plating. Therefore, the transmitting surface 21s of the transmitting portion 21, and the design surface 22s and the general surface 22gs of the design portion 22, each exhibit metallic luster.

In the vehicle camera unit 1 of embodiment 1, the design surface 22s and the general surface 22gs of the design portion 22 have the same design coat layer formed thereon. The design coat layer has the same color and luster as the transmitting coat layer so that the boundary therebetween is less likely to be recognized at first glance.

Thus, the garnish member 20 in the vehicle camera unit 1 of embodiment 1 exhibits a design having a sense of unity.

Although the design surface 22s and the general surface 22gs of the design portion 22 have the same design coat layer formed thereon in the vehicle camera unit 1 of embodiment 1, the design surface 22s and the general surface 22gs may have different design coat layers formed thereon.

As shown in FIG. 2 and FIG. 4, the back camera 11 is provided with the lens 12 directed in the rearward downward direction. As shown in FIG. 4, the lens 12 of the back camera 11 is covered by the transmitting portion 21 of the garnish member 20 from the rear lower side. Since the transmitting portion 21 is a half mirror, the lens 12 covered by the transmitting portion 21 is less likely to be visually recognized by a user or the like.

A lower part 13 of the back camera 11, located upward of the lens 12, is covered by the design portion 22 of the garnish member 20 from the rear upper side. Since the design portion 22 has the design coat layer which is the plating layer, the visible light transmittance of the design portion 22 is smaller than the visible light transmittance of the transmitting portion 21, and is approximately 0%. Therefore, the lower part 13 of the back camera 11 covered by the design portion 22 is even less likely to be visually recognized by the user or the like than the lens 12 of the back camera 11.

Further, as shown in FIG. 4, the design portion 22 has the design surface 22s facing in the rearward upward direction. Of the garnish member 20, the design surface 22s readily comes into sight of the user or the like who stands at the rear of the back door 91, and is a part that attracts attention of the user or the like. The design surface 22s exhibits the design derived from the design coat layer and shields visible light by the design coat layer which is the plating layer.

The back camera 11 in the vehicle camera unit 1 of embodiment 1 is placed behind, i.e., frontward of the design portion 22 which attracts attention of the user or the like and shields visible light, as described above. This has a great advantage of taking attention of the user or the like away from the lens 12 which is likely to be recognized by the user or the like, thus suppressing deterioration in the design of the vehicle 90 due to mounting of the back camera 11.

In other words, the vehicle camera unit 1 of embodiment 1 is configured such that the back camera 11 is placed on the inner side of the design so as to attract attention of the user or the like to the design, thus taking the attention away from the lens 12.

As described above, the lens 12 of the back camera 11 is covered by the transmitting portion 2l from the rear side. Therefore, for example, when the user or the like looks into the back camera 11 from a downward side of the back door 91, the transmitting portion 21 comes into sight of the user.

Meanwhile, when the back door 91 is opened, the positions of the lens 12 and the transmitting portion 21 are changed, so that the transmitting portion 21 covers the rear upper side of the lens 12. In this case, the transmitting portion 21 instead of the design portion 22 comes into sight of the user.

However, since the transmitting portion 21 is a half mirror, also in the above cases, the lens 12 of the back camera 11 is hidden by the transmitting portion 21 and thus is still less likely to be visually recognized by the user or the like.

In the vehicle camera unit 1 of embodiment 1, the body-side member 30 is provided upward of the garnish member 20. As shown in FIG. 4, the body-side member 30 extends upward and has a recessed attachment portion 35 at the lower end thereof. The recessed attachment portion 35 has a groove shape that opens rearward and downward, and a projecting attachment portion 25 which is an upper end portion of the design portion 22 enters into the groove.

Thus, a substantial parting portion between the garnish member 20 and the body-side member 30 in the vehicle camera unit 1 of embodiment 1 is hidden in the groove of the recessed attachment portion 35. Thus, the design at the parting portion between the body-side member 30 and the design portion 22 is improved.

An upper part of the design portion 22 and a lower part of the body-side member 30 are directed in directions crossing each other, and thus the garnish member 20 and the body-side member 30 are considered to be connected in a cornered shape at the parting portion. Therefore, the projecting attachment portion 25 and the recessed attachment portion 35 located at the boundary between the design portion 22 and the body-side member 30 are hidden at the deep part of the corner. This also improves the design of the parting portion between the garnish member 20 and the body-side member 30.

In the vehicle camera unit 1 of embodiment 1, the recessed attachment portion 35 has a groove shape that opens rearward and downward. However, the recessed attachment portion 35 in the vehicle camera unit 1 of the present invention is not limited to the above shape.

For example, as shown in FIG. 5, the recessed attachment portion 35 may have a groove shape that opens rearward and is closed on the downward side. In this case, the recessed attachment portion 35 and the projecting attachment portion 25 are stably engaged with each other, and the substantial parting portion between the garnish member 20 and the body-side member 30 is highly reliably hidden in the groove of the recessed attachment portion 35. Therefore, also in this case, the design at the parting portion between the body-side member 30 and the design portion 22 is improved.

The present invention is not limited to only the embodiment described above and shown in the drawings, but may be modified as appropriate without deviating from the scope of the present invention. In addition, the components shown in the description including the embodiment may be optionally taken out and combined with each other to carry out the present invention.

1. A vehicle camera unit comprising:
aback camera mounted to a rear part of a vehicle and configured to take an image rearward;
a garnish member provided rearward of the back camera; and
a body-side member provided upward of the garnish member, wherein
the back camera has a lens directed rearward,
the garnish member includes a transmitting portion which is a half mirror and covering the lens at least from a rear side, and a design portion provided upward of the transmitting portion and covering a lower part of the back camera from a rear upper side,
the design portion is a half mirror or a visible light transmittance of the design portion is smaller than a visible light transmittance of the transmitting portion,
the body-side member has, at a lower end thereof, a recessed attachment portion having a groove shape that opens rearward, and
the design portion has, at an upper end thereof, a projecting attachment portion entering into the recessed attachment portion.

2. A vehicle camera unit comprising:
aback camera mounted to a rear part of a vehicle and configured to take an image rearward; and
a garnish member provided rearward of the back camera, wherein
the back camera has a lens directed rearward,
the garnish member includes a transmitting portion which is a half mirror and covering the lens at least from a rear side, and a design portion provided upward of the transmitting portion and covering a lower part of the back camera from a rear upper side, and
the design portion is a half mirror or a visible light transmittance of the design portion is smaller than a visible light transmittance of the transmitting portion.

3. The vehicle camera unit according to claim 1, wherein
the visible light transmittance of the design portion is smaller than the visible light transmittance of the transmitting portion, and
the design portion has a plating layer.

4. The vehicle camera unit according to claim 2, wherein
the visible light transmittance of the design portion is smaller than the visible light transmittance of the transmitting portion, and
the design portion has a plating layer.

5. The vehicle camera unit according to claim 1, wherein
the transmitting portion has a transmitting surface facing in a rearward downward direction, and
the design portion has a design surface facing in a rearward upward direction.

6. The vehicle camera unit according to claim 2, wherein
the transmitting portion has a transmitting surface facing in a rearward downward direction, and
the design portion has a design surface facing in a rearward upward direction.

7. The vehicle camera unit according to claim 1, the vehicle camera unit being provided to a back door and further comprising a handle of the back door, wherein
the back camera is provided upward of the handle, and
the garnish member is provided rearward of the back camera and the handle.

8. The vehicle camera unit according to claim 2, the vehicle camera unit being provided to a back door and further comprising a handle of the back door, wherein
the back camera is provided upward of the handle, and
the garnish member is provided rearward of the back camera and the handle.
